(19) United States
(12) Patent Application Publication
(10) Pub. No.: US 2006/0065596 A1
(43) Pub. Date: Mar. 30, 2006

(54) Membrane filter cleansing process

(76) Inventors: Fraser Charles Kent, Milton (CA); David Brian Ross, Burlington (CA)

Correspondence Address: BERESKIN AND PARR, 40 KING STREET WEST, BOX 401, TORONTO, ON, M5H 3Y2, CA

(21) Appl. No.: 10/961,077

(22) Filed: Oct. 12, 2004

(30) Foreign Application Priority Data
Sep. 24, 2004 (CA) 2,482,517

(51) Int. Cl. B01D 65/02

(52) U.S. Cl. 210/636; 210/650; 210/321.69

(57) ABSTRACT

Immersed hollow-fiber membrane filtration systems sometimes encounter process problems as a result of solids accumulation in and around the hollow fibers. The solids can accumulate to the point where they begin to dewater and form a mud like substance known as sludge. In some embodiments of the invention there is provided a process for substantially preventing the accumulation of sludge build-up on membrane fibers and/or cleansing membrane fibers that have been fouled by a substantial sludge build-up. Many of these embodiments involve aerating a membrane tank in which the membrane fibers are immersed after the water level has been reduced to near the level of solids accumulation. In some embodiments of the invention, the energy released by bursting bubbles at the liquid-air interface is employed to prevent fouling of membrane fibers and/or cleanse fouled membrane fibers.

### FIELD OF THE INVENTION

This invention relates to membrane filtering systems, and in particular to a cleansing process for membrane filtering systems.

### BACKGROUND OF THE INVENTION

Immersed membranes are used for separating a permeate lean in solids from tank water rich in solids. Filtered permeate passes through the walls of the membranes under the influence of a transmembrane pressure differential between a retentate side of the membranes and a permeate side of the membranes. Solids in the tank water are rejected by the membranes and remain on the retentate side of the membranes. Despite the simplicity of this process, the need to clean membrane fibers, to prevent their rapid and sometimes irreversible loss of permeability, is difficult to address.

A batch filtration process may have a repeated cycle of concentration, or permeation, and deconcentration steps. During the concentration step, permeate is withdrawn from a batch of feed water initially having a low concentration of solids. As the permeate is withdrawn, fresh water is introduced to replace the water withdrawn as permeate. During this step, which may last from 10 minutes to 4 hours, solids are rejected by the membranes and do not flow out of the tank with the permeate. As a result, the concentration of solids in the tank increases, for example to between 2 and 100, more typically 5 to 50, times the initial concentration. The process then proceeds to the deconcentration step. In the deconcentration step, which may be between 1/50 and 1/5 the duration of the concentration step, a large quantity of solids are rapidly removed from the tank to return the solids concentration back to a lower concentration.

As filtered water is permeated through the membranes, solids foul the surface of the membranes. The rate of fouling is related to the concentration of solids in the tank water and can be reduced but not eliminated. Further, the solids may be present in the feed water in solution, in suspension or as precipitates and may further include a variety of substances, some not actually solid, including colloids, microorganisms, exopolymeric substances excreted by microorganisms, suspended solids, and poorly dissolved organic or inorganic compounds such as salts, emulsions, proteins, humic acids, and others. All of these solids can contribute to fouling but the fouling may occur in different ways. Fouling can also occur at the membrane surface or inside of the pores of the membrane. To counter the different types of fouling, many different types of cleaning regimens may be required. Such cleaning may include both physical cleaning and chemical cleaning.

The most frequently used methods of physical cleaning are backwashing and aeration, which may also be called air scouring. In backwashing, permeation through the membranes is stopped momentarily. Air or water are flowed through the membranes in a reverse direction to physically push solids off of the membranes. In aeration, bubbles are produced in the tank water in which the membranes are immersed. As the bubbles rise, they agitate or scrub the membranes and thereby remove some solids. These two methods may also be combined and both may be performed at the end of the concentration step.

Examples of chemical cleaning methods are described in U.S. Pat. No. 5,403,479 in which chemical cleaning is performed without draining the tank or removing the membranes from the tank. In drinking water applications, the chemicals pass through the membranes when permeation is resumed resulting in unwanted concentrations of chemicals in the permeate.

### SUMMARY OF INVENTION

It is an object of the present invention to improve on, or provide a useful alternative to, the prior art. It is another object of the invention to provide a method of cleaning immersed membranes or a filtration process using immersed membranes. The following summary is intended to introduce the reader to the invention but not to define it. The invention may reside in a combination or sub-combination of one or more apparatus elements or process steps described in this or other parts of this document or in the claims.

The inventors have observed that, despite regular backwashing, aeration or chemical cleaning, solids or sludge may still accumulate around the membrane fibers. In particular, sludge may build up in a layer above a lower header of a module of vertical fibers or in other areas of these or other types of modules that are difficult to contact with bubbles under ordinary air scouring. According to aspects of an embodiment of the invention there is provided a process for reducing the accumulation of sludge build-up on membrane fibers immersed in a liquid including: reducing the level of the liquid to or near an area of the membrane fibers having an accumulation of sludge and providing air scouring for a period of time with the liquid at this level in order to dislodge sludge or solids from the membrane fibers. While the invention is not limited to this theory, the inventors believe that energy released by the bubbles bursting at the lowered water surface is highly effective at removing sludge or solids build ups from problem areas in a module. The sludge may be removed from the membrane tank directly thereafter by draining the rest of the tank, or removed later.

In some embodiments the process described above is combined with steps for the operation of a filtering system, for example one having a cycle of permeation and deconcentration.

Other aspects and features of the present invention will become apparent upon review of the following description of exemplary embodiments of the invention.

### BRIEF DESCRIPTION OF THE DRAWINGS

For a better understanding of the present invention, and to more clearly show how it may be carried into effect, reference will now be made, by way of example, to the accompanying drawings that illustrate aspects of embodiments of the invention and in which:

FIG. 1 is a flow diagram of a first process according to an embodiment of the invention;

FIG. 2 is a flow diagram of a second process according to another embodiment of the invention;

FIG. 3 is a schematic diagram of an apparatus suitable for use with the processes illustrated in FIGS. 1 and 2;

FIG. 4A is a schematic diagram of a membrane tank, shown in FIG. 3, before the process illustrated in FIG. 1 is applied;

FIG. 4B is a schematic diagram of the membrane tank, shown in FIG. 4A, at a step in the process illustrated in FIG. 1; and

FIG. 5 is the membrane tank, shown in FIG. 3, at a step in the process illustrated in FIG. 2.

### DETAILED DESCRIPTION OF THE INVENTION

As described above immersed hollow-fiber membrane filtration systems sometimes encounter process problems as a result of solids accumulation in and around the hollow-fibers. The solids can accumulate to the point where they begin to dewater and form a mud-like substance known as sludge. In some modules, solids or sludge tends to accumulate primarily in certain locations, for example directly above the lower header in a module of vertical fibers. In some embodiments of the invention there is provided a process for removing solids from the fibers to substantially prevent the accumulation of sludge build-up on the fibers or clean fibers that have been fouled by a substantial sludge build-up. Many of these embodiments involve providing aeration to a membrane tank in which the membrane fibers are immersed.

Aerating a membrane tank involves pumping air into the tank in a manner that provides bubbles that rise through the liquid in the tank. For example, the air may be pumped into aerators below or integrated with membrane modules or cassettes. As the bubbles rise through the tank, they create turbulence and shear forces on the surface of the membrane fibers, which control fouling and sludging to some extent. It has also been found by the inventors that when the bubbles reach the liquid-air interface, which is above the membrane fibers during permeation, they release a surprising amount of energy when they burst at the liquid-air interface. In some embodiments of the invention, the energy released by bursting bubbles at the liquid-air interface is employed to prevent fouling of membrane fibers and/or cleanse fouled membrane fibers. In such embodiments, a process for preventing and/or cleaning away sludge involves adjusting the water level to a level near where the most extensive membrane fouling and/or sludge build-up is observed and aerating for a period of time, such that the energy released at the liquid-air interface may act on the sludge, before refilling the membrane tank and continuing permeation or continuing to drain the tank fully. Adjusting the water level to specific areas provides those specific areas with the enhanced scouring that results from the bursting bubbles at the liquid-air interface. Typically, the specific areas targeted will be those areas prone to experiencing sludge build-up, such as the area directly above a lower header. This type of prevention and/or cleansing process is beneficial in reducing the amount of sludge that may otherwise accumulate on membrane fibers or removing sludge that has accumulated. Moreover, this type of prevention and/or cleansing process may allow membrane filters to be employed in conditions where severe and detrimental sludging can occur.

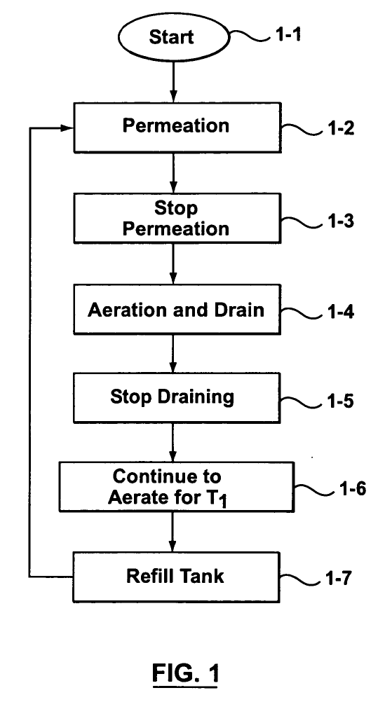

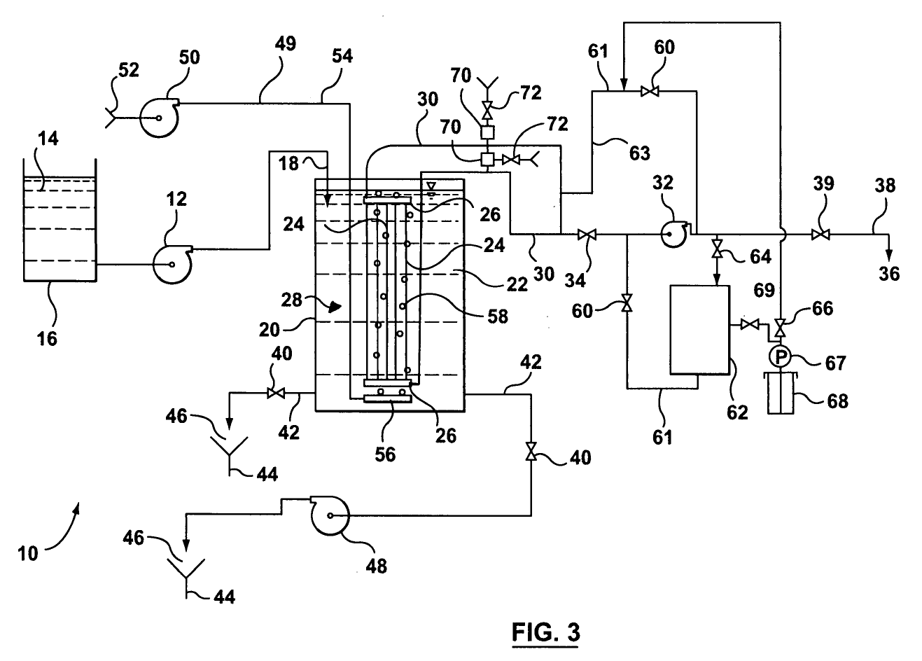

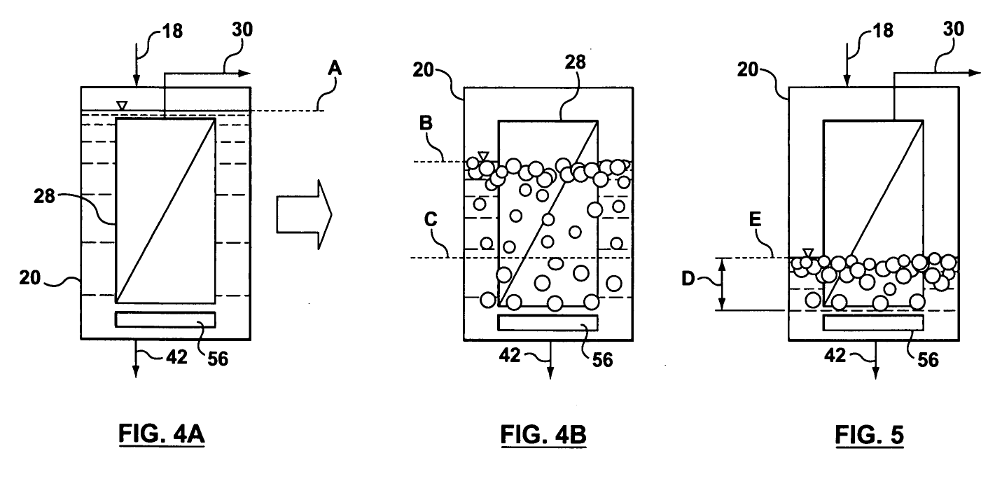

Referring now to FIG. 1, a first process for preventing and cleansing membrane fibers within a membrane tank is illustrated in a flow chart. The process includes an initialization step 1-1, a permeation step 1-2, a stop-permeation step 1-3, a drain and aeration step 1-4, a stop draining step 1-5, a continued aeration step 1-6 and a tank refill step 1-7. These steps may be performed solely for the purpose of cleaning the membranes, may be integrated with another process involving draining the tank or may be used to form all or part of a cycle of concentration and deconcentration that is repeated frequently during the batch operation of a filtering system. Each step will be described in greater detail below with reference to FIGS. 3, 4A and 4B.

In the initialization step 1-1, a feed pump 12 pumps feed water 14 from a water supply 16 through an inlet 18 to a tank 20 where it becomes tank water 22. The tank 20 is filled when the level of the tank water 22 completely covers one or more membranes 24 in the tank 20.

During the permeation step 1-2, permeate 36 is withdrawn from the tank 20 through the membranes 24. The membranes 24 have a permeate side which does not contact tank water 22 and a retentate side which does contact the tank water 22. Membranes 24 made of hollow fibres may have an average pore size in the microfiltration or ultrafiltration range, for example between 0.01 microns and 10 microns. The membranes 24 are attached to headers 26 to produce a watertight connection between the retentate side of the membranes 24 and the headers 26 while keeping the permeate sides of the membranes 24 in fluid communication with at least one conduit in at least one header 26. The membranes 24 and headers 26 together form a membrane module 28, such as ZEEWEED™ 500 or 1000 series modules made by Zenon Environmental Inc. The module 28 may be oriented with the membranes 24 oriented horizontally or vertically. The conduit or conduits of the headers 26 are connected to a permeate collector 30 and a permeate pump 32 through a permeate valve 34. A plurality of membrane modules 28 (not shown) may be connected to a common permeate collector 30.

During the permeation step 1-2, drain valves 40 are closed. The permeate valve 34 and an outlet valve 39 are opened and the permeate pump 32 is on. A negative pressure is created on the permeate side of the membranes 24 relative to the tank water 22 surrounding the membranes 24. The resulting transmembrane pressure, which may be between 1 kPa and 150 kPa, draws tank water 22 (then referred to as permeate 36) through the membranes 24 while the membranes 24 reject solids that remain in the tank water 22. Thus, filtered permeate 36 is produced for use at a permeate outlet 38. Periodically, a storage tank valve 64 is opened to admit permeate 36 to a storage tank 62. The filtered permeate 36 may require post treatment, before being used as drinking water for example, but should have acceptable levels of solids. As filtered permeate 36 is removed from the tank, the feed pump 12 is operated to keep the tank water 22 at a level which covers the membranes 24.

In a batch process, the permeation step 1-2 may continue for between 15 minutes and three hours, for example between 45 minutes and 90 minutes but may be repeated and may have intervening backwashing or deconcentration steps. In a feed and bleed process, the permeation step 1-2 may continue for more extended periods of time although permeation may still be periodically interrupted, for example by backwashing or other steps. During the permeation step 1-2, solids may accumulate in the tank water 22 and permeability of the membranes 24 may decrease as the membranes 24 foul. The end of the permeation step may be determined by the membranes 24 dropping to a preselected permeability, by a duration of time having elapsed, by a time or a time and day having been reached, by an amount of permeate having been produced or other means. At this time, the permeation step 102 is ended. In the stop permeation step 1-3, the permeate pump 32 and feed pumps 12 are turned off and the permeate valve 34 and outlet valves 39 are closed. The end of the permeation step 1-2 may be chosen to coincide with a time when the tank would be drained anyway, for example a deconcentration step in a batch process or an empty tank cleaning step in a feed and bleed process. In a batch process, the following steps may replace an ordinary deconcentration or may be the ordinary means of deconcentiontion of the tank.

At step 1-4, the cleansing process begins with an initialization of draining of the membrane tank 20, and starting aeration as well. Optionally, the start of aeration may precede the start of the tank drain, or the start of the tank drain may precede the start of aeration, although it is preferred if aeration is started at least by the time the liquid level is at or near the top of the module 28.

In order to drain the membrane tank 20, the drain valves 40 are opened to allow tank water 22, then containing a high concentration of solids and called retentate 46, to flow from the tank 20 through a retentate outlet 42 to a drain 44. The retentate pump 48 may be turned on to drain the tank more quickly, but in many installations the tank will empty rapidly enough by gravity alone. In most industrial or municipal installations it may ordinarily take between two and ten minutes, and more frequently between two and five minutes, to drain the tank 20 completely. Aeration continues during draining.

Referring to FIG. 4A, the tank water 22 is shown above the membrane module 28 at a level A before step 1-4. Subsequently, as shown in FIG. 4B, a lower level B illustrates an intermediary level of the tank water 22 as it is draining during step 1-4. As the tank drains, the solid-liquid interface, with bubbles bursting at it, passes across a large portion, for example 50% or more, of the surface area of the membranes 24. At step 1-5 draining is paused or stopped at the level C, which is near the top of the approximate level of a region where sludge accumulation is known or suspected to occur on the membranes 24. This allows the energy of bursting bubbles to scour an effective area near the liquid-air interface preferably including an area known to have sludging problems. Optionally, draining may also be paused or stopped at one or more additional levels corresponding to regions where sludge accumulation is known or suspected to occur.

Aeration in steps 1-4 or 1-5 is provided by an aeration system 49 having an air supply pump 50 which blows air, nitrogen or other appropriate gas from an air intake 52 through air distribution pipes 54 to one or more aerators 56 located generally below the membrane modules 28 which disperse air bubbles 58 into the tank water 22. The rate of aeration may be between 10 and 60 delivered cfm per square meter of area, in plan view, of a module 28. The air bubbles 58 rise to the air-liquid interface where they burst, releasing energy and causing turbulence in the tank water 22.

Optionally, backwashing may also occur during or between any of steps 1-2 to 1-7 or at two or more of these times. For example, backwashing may be provided for about 30 seconds within step 1-6, or between steps 1-3 and 1-4. Two types of backwashing may be used—permeate or chemical. For permeate backwashing, backwash valves 60 and storage tank valve 64 are opened. Permeate pump 32 is turned on to push filtered permeate 36 from storage tank 62 through a backwash pipe 63 to the headers 26 and through the walls of the membranes 24 in a reverse direction thus pushing away some of the solids attached to the membranes 24. At the end of the backwash, backwash valves 60 are closed. As an alternative to using the permeate pump 32 to drive the backwash, a separate pump can also be provided in the backwash line 63 which may then by-pass the permeate pump 32. By either means, the backwashing continues for between 15 seconds and one minute after which time the backwash step 106 is over. Permeate pump 32 is then turned off and backwash valves 60 closed. For chemical backwashing, a chemical valve 66 is opened and a chemical pump 67 turned on to flow chemical cleaner from a chemical tank 68 to backwash line 63 connected to headers 26 and thus to the membranes 24. Alternatively, backwash valves 60 are opened and permeate pump 32 operated to push filtered permeate 36 from permeate tank 62 through backwash line 63 to the headers 26. Chemical valve 66 is opened and chemical pump 67 is turned on, mixing chemical cleaner from chemical tank 68 with permeate 36 flowing through backwash line 63. Further alternatively, backwash valves 60 and a cross flow valve 69 are also opened connecting the chemical tank 68 to the permeate tank 62. Chemical pump 67 delivers chemical cleaner to permeate tank 62. Permeate pump 32 is then operated to deliver the chemical cleaner to the membranes 24. Chemical cleaners could also be introduced directly to the headers 26 or the permeate collector 30 which may reduce the total volume used or allow alternate delivery mechanisms.

The permeate pump 32 or chemical pump 67, whichever governs, is controlled to feed the cleaning chemical into the membranes 24 with sufficient pressure to produce a flux of chemical through the membranes 24 between 8.5 L/m²/h and 51 L/m²/h. New chemical cleaner is added to the chemical tank 68 as needed. After the chemical cleaning is completed, chemical pump 67 is turned off and chemical valve 66 or cross flow valve 69 is closed. Preferably, the backwash valves 60 are opened and permeate pump 32 operated to provide a rinsing backwash to remove chemical cleaner from the backwash line 63 and permeate collectors 30.

As indicated at step 1-6, the aeration continues at level C during the period of time T₁ which may be in the range of 30 seconds to 20 minutes. Subsequently, membrane tank 20 is refilled at step 1-7. Optionally, some or all of the remainder of the tank may be drained before step 1-7 to dislodge sludge and further deconcentrate the tank. Aeration may remain on while the tank is drained further. Alternatively, the dislodged sludge may be removed during a later deconcentration, repetition of steps 1-3 to 1-7 or retentate bleed. Since this method may be used to provide at least some aeration to the entire surface area of the membranes 24, this method may be used to replace other aeration steps that would otherwise be used in a process. T₁ may be chosen depending on how frequently the method is performed. For example, the method may be performed between twice a day and once a week, in which case T₁ is chosen more to prevent large sludge build ups from occurring rather than to remove an existing sludge build up and may be between 30 seconds and 5 minutes. If the method is performed less frequently, for example between twice a week and once every two months, T₁ maybe larger, for example between 2 minutes and 20 minutes.

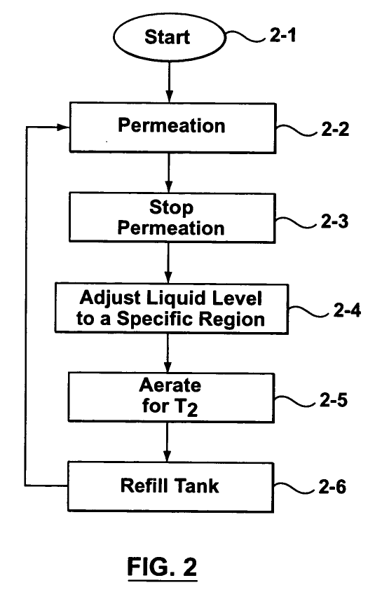

Referring now to FIG. 2, a second process for preventing fouling or cleansing membrane fibers within a membrane tank is illustrated in a flow chart. The process includes an initialization step 2-1, a permeation step 2-2, a stop-permeation step 2-3, a liquid level adjustment step 2-4, an aeration step 2-5, and a membrane tank refill step 2-6. These steps may be performed solely for the purpose of cleaning the membranes, may be integrated with another process involving draining the tank or may be used to form all or part of a cycle of concentration and deconcentration that is repeated frequently during the batch operation of a filtering system. Each step will be described in greater detail below with reference to FIG. 5 and continued reference to FIG. 3.

Steps 2-1 to 2-3 are identical to steps 1-1 to 1-3, respectively, that were described above with respect to FIGS. 1, 3, 4A and 4B. Other aspects of the method of FIG. 2 are also the same as, or similar to, the method of FIG. 1 and so will not be repeated. With continued reference to FIG. 3 and FIG. 5, starting at step 2-4, the liquid level in the membrane tank 20 is lowered to a level E at, or near the top of, an area where sludge may accumulate. Level E, or Level C in FIG. 4B, may be within 30 cm of the bottom of the membranes, for example within 30 cm of the top of the lower header of a module of vertical fibers or within 20 cm or 15 cm of a bottom header of a module 28 of vertical fibers 24. Modules 28 of other configurations may have other areas where sludge may accumulate.

At step 2-5, aeration is provided for a period of time T₂, which may be in the range of 30 seconds to twenty minutes. The bursting bubbles provide enough turbulence to effectively scour the membrane fibers a depth D below the liquid-air interface at level E. This depth is dependent on the intensity of the aeration and in the present example it may be up to 30 cm below level E and/or sufficient to reach the bottom of the membrane fibers or the top of a lower header in a module with vertical fibers. Steps 2-4 and 2-5 may be repeated one or more times at different liquid levels if there are multiple areas of the module 28 prone to sludging or solids build ups. After the last aeration step 2-5, the membrane tank is refilled at step 2-6 optionally after further or fully draining the tank to immediately remove the dislodged sludge. Because this method does not provide aeration for the entire surface area of the membranes, this method is typically used when another aeration step affecting the entire membrane surface area is provided during another part of the process, for example during step 2-2 or between steps 2-3 or 24. The precise duration of T₂ may be the same as, and chosen as described for, T₁. In either method, T₁ or T₂ may also be variable or the methods may be combined. For example, the method of either FIG. 1 or FIG. 2 may be performed frequently with a short T_{1 or T}₂ while, in the same process, the method of either FIG. 1 or FIG. 2 is additionally performed less frequently and with a larger T₁ or T₂.

While the above description provides examples according to aspects of embodiments of the invention, it will be appreciated that the present invention is susceptible to modification and change without departing from the fair meaning and scope of the accompanying claims. For example and without limitation, the tank water 22 may be a wastewater as well as water being filtered to provide drinking, municipal or process water. Further, the tank may be refilled after step 1-6 or 2-6 without draining below the pause level with the sludge removed later by concentrate bleed or in the next deconcentration, cleaning or tank drain. Further, the invention may be used with non-batch processes, for example by draining the tank in steps 1-4 or 2-4 to another reservoir and then refilling the tank from that reservoir or by performing the invention only as frequently as a drain of the tank can be tolerated or as required for other reasons. Accordingly, what has been described is merely illustrative of the application of some aspects of embodiments of the invention. It is therefore to be understood that within the scope of the appended claims, the invention may be practiced otherwise than as specifically described herein.

We claim:

1. A process for removing solids from a module of membrane fibers immersed in a liquid comprising:
(a) reducing the level of the liquid to a level corresponding to an area of the membrane fibers having an accumulation of solids; and,
(b) providing aeration for a period of time while the liquid is at the level corresponding to the area of the membrane fibers having the accumulation of solids in order to dislodge at least a portion of the solids from the membrane fibers.

2. A process according to claim 1 further comprising, after step (b), draining the remaining liquid.

3. A process according to claim 1 further comprising re-immersing the membrane fibers after step (b) of claim 1.

4. A process according to claim 1, wherein the liquid level at step (b) of claim 1 is near the bottom header of a module of vertically oriented fibers.

5. A process according to claim 1 wherein the liquid level at step (b) of claim 1 is within 30 cm of the top of the lower header of a module of vertically oriented hollow fibers

6. A process according to claim 1, wherein step (b) is provided for between about 30 seconds and 20 minutes.

7. A process according to claim 1, wherein the steps occur in less than 30 minutes.

8. A process according to claim 1 wherein the steps occur in less than 15 minutes.

9. A process according to claim 1, wherein the steps of claim 1 are incorporated into the regular operation of a batch filtering system having a cycle of permeation and deconcentration by using the steps of claim 1 to provide a deconcentration.

10. A process according to claim 1 wherein the membranes are aerated during step (a).

11. A process according to claim 1 further comprising, after step (b) of claim 1,
(c) reducing the level of the liquid to a second level corresponding to an area of the membrane fibers having an accumulation of solids; and,
(d) providing aeration for a period of time while the liquid is at the second level corresponding to the areas of the membrane fibers having the accumulation of solids in order to dislodge at least a portion of the solids from the membrane fibers.
